(19) United States
(12) Patent Application Publication
(10) Pub. No.: US 2018/0298258 A1
(43) Pub. Date: Oct. 18, 2018

(54) Anti-Fogging Agent

(71) Applicant: CEKO CO., LTD., Gyeonggi-do (KR)

(72) Inventors: Masahiro SATOH, Kyoto (JP); Satsuki KITAJIMA, Kyoto (JP)

(73) Assignee: CEKO CO., LTD., Gyeonggi-do (KR)

(21) Appl. No.: 15/767,017

(22) PCT Filed: Oct. 7, 2016
(86) PCT No.: PCT/KR2016/011257

§ 371 Date: Apr. 9, 2018

(30) Foreign Application Priority Data
Oct. 9, 2015 (JP) 2015-200819

(51) Int. Cl. C09K 3/18; C07F 7/18; C09D 7/40

(52) U.S. Cl. CPC C09K 3/18; C09D 7/40; C07F 7/1836

(57) ABSTRACT

The present invention relates to an anti-fogging agent which is for preventing fogging even during exposure to vapor. The purpose of the present invention is to provide an ideal hydrolysis product of surface-active silane coupling agent and a transformed metal oxide sol which is transformed by means of a hydrolysis product of a surface-active silane coupling agent. A hydrolysis product of a surface-active silane coupling agent, according to the present invention, is a reaction product of a surfactant in formula (1) below and a silane coupling agent having the functional groups reactable with active hydrogen in formula (1). Formula (1): R¹—X—(CH₂CH₂O)ₙ—Y, wherein R¹ is alkyl group having from 1 to 20 carbon atoms, X is —O—, —COO— or —CONH—, n is a natural number from 1 to 30, and Y is a hydrogen atom, —CH₂COOH.

### FIELD

The present invention relates to a hydrolysate of surface-active silane coupling agent having a great antifog effect which is coatable and prepared at low cost, and a modified metal oxide sol which is modified by the hydrolysate of surface-active silane coupling agent.

### BACKGROUND

The present inventors already have a granted patent of a modified metal oxide sol having a sulfonic acid group (Patent document 1). Although the substrate (glass, plastic, metal, etc.) applied by a hydrophilic coating solution comprising the traditional modified metal oxide sol shows hydrophilic property, it does not show antifog effect. And when the lens treated by the coating solution is exposed to steam, water drops generate and sight becomes poor.

As the patent of the antifog additive, an antifog additive using phosphoric ester-type emulsifier (Patent document 2) and an antifog additive using polyacrylic acids (Patent document 3) are filed.

### PATENT DOCUMENTS

(Patent document 1) JP 5750436 B

(Patent document 2) JP 2006-16578 A

(Patent document 3) JP 2011-153164 A

### DETAILED DESCRIPTION

### Technical Problem

The purpose of the present invention is to provide a hydrolysate of surface-active silane coupling agent which is suitable for an antifogging additive preventing fog when exposed to steam, and a modified metal oxide sol which is modified by the hydrolysate of surface-active silane coupling agent.

### Technical Solution

In order to achieve the technical purpose, the present invention provides a hydrolysate of surface-active silane coupling agent which is suitable for an antifogging additive, and a modified metal oxide sol which is modified by the hydrolysate of surface-active silane coupling agent.

The present invention comprises the below technical solutions.

[1] A hydrolysate of surface-active silane coupling agent which is a reaction product of a surfactant represented by the following Formula (1) and a silane coupling agent having a functional group which can react with active hydrogen of the Formula (1):

R¹—X—(CH₂CH₂O)ₙ—Y (1)

wherein R¹ is C₁ to C₂₀ alkyl group (the alkyl group may comprise a benzene ring and double bond), X is —O—, —COO— or —CONH—, n is a natural number of 1 to 30, and Y is hydrogen or —CH₂COOH.

[2] A modified metal oxide sol which is obtained by modifying a metal oxide sol with the above hydrolysate of surface-active silane coupling agent.

[3] The modified metal oxide sol further comprising at least one of the silicon-based compounds represented by the following Formula (2):

X—(R³)ₘ—Si(CH₃)ₙ(—Y)₃₋ₙ (2)

wherein X is selected from the group consisting of a C₁ to C₂₀ linear or branched alkyl group, vinyl group, thiol group, amino group, chlorine atom, acryl group, methacryl group, styryl group, phenyl group, glycydoxy group, 3,4-epoxycyclohexyl group and blocked isocyanate group, R³ is C₁ to C₅ alkylene, m is 0 or 1, Y is same or different C₁ to C₄ alkoxy group or hydroxyl group, and n is 0 or 1.

[4] The modified metal oxide sol according to [2] or [3], wherein the metal oxide sol as a raw material of the modified metal oxide sol is organo-silica sol.

[5] An antifog additive comprising:

a hydrolysate of surface-active silane coupling agent according to [1] and/or

one or more modified metal oxide sols according to any of [2] to [4].

[6] An antifog coating composition comprising:

a hydrolysate of surface-active silane coupling agent according to [1] and/or

one or more modified metal oxide sols according to any of [2] to [4].

[7] A structure which is obtained by coating and curing the antifog coating composition according to [6].

### Advantageous Effects

The present invention relates to a hydrolysate of surface-active silane coupling agent having a great antifog effect which is coatable and prepared at low cost, and a modified metal oxide solution (may abbreviated to as “a hydrolysate of surface-active silane coupling agent group” hereinafter) which is modified by the hydrolysate of surface-active silane coupling agent.

The antifog additive of the present invention comprising the hydrolysate of surface-active silane coupling agent group prevents fog when exposed to steam.

Since the antifog additive comprising the hydrolysate of surface-active silane coupling agent group has a good antifog effect for glass or plastic, etc., it is suitable as an antifog additive for glass, lens of eyeglasses, optical lens, mirror, etc. Moreover, since the antifog additive is coatable and prepared at low cost, it is suitable for a hydrophilizing agent, an antistatic agent, a hydrophilic coating composition, antimicrobial agent, ion (proton) conductor as well as an antifog additive.

### DISCLOSURE OF THE INVENTION

The present invention will be described in detail in below.

A hydrolysate of surface-active silane coupling agent of the present invention is a reaction product of a surfactant represented by the above Formula (1) and a silane coupling agent having a functional group which can react with active hydrogen of the Formula (1).

In the compound of the above Formula (1), a raw material of the silane coupling agent, C₁ to C₂₀ alkyl group (the alkyl group may comprise a benzene ring and double bond) of R¹ may be methyl group, ethyl group, octyl group, decyl group, dodecyl group, tetradecyl group, pentadecyl group, hexadecyl group, palmitoleic acid group, heptadecyl group, octadecyl group, oleyl group, etc. Considering the convenience of acquiring the raw material, methyl group, dodecyl group and heptadecyl group are preferred.

X is —O—, —COO— or —CONH—.

n is a natural number of 1 to 30, and 1 to 9 are preferred considering the convenience of acquiring the raw material and handling it in liquid form.

Y is hydrogen or —CH₂COOH.

The compound of the Formula (1) is surfactant, and the surfactant commercially available can be used.

In the commercially available surfactant comprising the compound of the Formula (1), the number of added ethylene oxides is commonly not certain. As a result, the surfactant is a mixture of the surfactants having different numbers of added ethylene oxides, not a single surfactant.

In the case of the mixture of the compounds of the Formula (1), it is preferred that n is averagely 9 or less considering the convenience of handling it in liquid form.

The concrete examples of the compounds of the Formula (1) are as follows:

CH₃O(CH₂CH₂O)₂H

CH₃O(CH₂CH₂O)₃H

CH₃O(CH₂CH₂O)₄H

CH₃O(CH₂CH₂O)₅H

CH₃O(CH₂CH₂O)₆H

C₁₂H₂₅O(CH₂CH₂O)₃CH₂COOH

C₁₂H₂₅O(CH₂CH₂O)₄CH₂COOH

C₁₂H₂₅O(CH₂CH₂O)₅CH₂COOH

C₁₃H₂₇O(CH₂CH₂O)₃CH₂COOH

C₁₂H₂₅O(CH₂CH₂O)₇H

C₁₂H₂₅O(CH₂CH₂O)₈H

C₁₂H₂₅O(CH₂CH₂O)₉H

C₁₂H₂₅O(CH₂CH₂O)₁₀H

C₁₂H₂₅O(CH₂CH₂O)₁₁H

C₁₇H₃₅COO(CH₂CH₂O)₉H

C₁₇H₃₃COO(CH₂CH₂O)₅H

C₁₇H₃₃COO(CH₂CH₂O)₉H

C₁₇H₃₃COO(CH₂CH_{2O})₁₄H

C₁₇H₃₅CONHCH₂CH₂OH

A silane coupling agent having a functional group which can react with active hydrogen of the compounds of the Formula (1) is the silane coupling agent having any of epoxy group, isocyanate group, acid anhydride group or amino group.

Preferred silane coupling agents having a functional group which can react with active hydrogen of the compounds of the Formula (1) are 3-glycydoxypropyltrimethoxysilane, 3-glycydoxypropyltriethoxysilane, 3-glycydoxypropylmethyldimethoxysilane, 3-glycydoxypropylmethyldiethoxysilane, 2-(3,4-epoxycyclohexyl)ethyltrimethoxysilane, 3-isocyanatepropyltriethoxysilane, 3-trimethoxysilylpropylsuccinic anhydride, 3-aminopropyltrimethoxysilane and 3-aminopropylmethyldimethoxysilane.

The concrete examples of the silane coupling agents having a functional group which can react with active hydrogen of the compounds of the Formula (1) are as follows:

CH₃—O—(CH₂CH₂O)₂CH₂CH(OH)CH₂OCH₂CH₂CH₂Si(OCH₃)₃

CH₃—O—(CH₂CH₂O)₂CH₂CH(OH)CH₂OCH₂CH₂CH₂Si(CH₃)(OCH₃)₂

CH₃—O—(CH₂CH₂O)₃CH₂CH(OH)CH₂OCH₂CH₂CH₂Si(OCH₃)₃

CH₃—O—(CH₂CH₂O)₃CH₂CH(OH)CH₂OCH₂CH₂CH₂Si(CH₃)(OCH₃)₂

C₁₂H₂₅—O—(CH₂CH₂O)₆CH₂CH(OH)CH₂OCH₂CH₂CH₂Si(OCH₃)₃

C₁₂H₂₅—O—(CH₂CH₂O)₆CH₂COOCH₂CH(OH)CH₂OCH₂CH₂CH₂Si(OCH₃)₃

C₁₂H₂₅—O—(CH₂CH₂O)₇CH₂CH(OH)CH₂OCH₂CH₂CH₂Si(OCH₃)₃

C₁₂H₂₅—O—(CH₂CH₂O)₇CH₂COOCH₂CH(OH)CH₂OCH₂CH₂CH₂Si(OCH₃)₃

C₁₂H₂₅—O—(CH₂CH₂O)₈CH₂COOCH₂CH(OH)CH₂OCH₂CH₂CH₂Si(OCH₃)₃

C₁₂H₂₅—O—(CH₂CH₂O)₉CH₂COOCH₂CH(OH)CH₂OCH₂CH₂CH₂Si(OCH₃)₃

CH₃—O—(CH₂CH₂O)₂CH₂CH₂OCONHCH₂CH₂CH₂Si(OC₂H₅)₃

CH₃—O—(CH₂CH₂O)₃CH₂CH₂OCONHCH₂CH₂CH₂Si(OC₂H₅)₃

C₁₀H₂₁—O—(CH₂CH₂O)₆CH₂CH₂OCONHCH₂CH₂CH_{2S}i(OC₂H₅)₃

C₁₀H₂₁—O—(CH₂CH₂O)₇CH₂CH₂OCONHCH₂CH₂CH₂Si(OC₂H₅)₃

C₁₀H₂₁—O—(CH₂CH₂O)₈CH₂CH₂OCONHCH₂CH₂CH₂Si(OC₂H₅)₃

C₁₀H₂₁—O—(CH₂CH₂O)₉CH₂CH₂OCONHCH₂CH₂CH₂Si(OC₂H₅)₃

C₁₂H₂₅—O—(CH₂CH₂O)₆CH₂CH₂OCONHCH₂CH₂CH₂Si(OC₂H₅)₃

C₁₂H₂₅—O—(CH₂CH₂O)₇CH₂CH₂OCONHCH₂CH₂CH₂Si(OC₂H₅)₃

C₁₂H₂₅—O—(CH₂CH₂O)₈CH₂CH₂OCONHCH₂CH₂CH₂Si(OC₂H₅)₃

C₁₂H₂₅—O—(CH₂CH₂O)₉CH₂CH₂OCONHCH₂CH₂CH₂Si(OC₂H₅)₃

C₁₂H₂₅—O—(CH₂CH₂O)₈CH₂CONHCH₂CH₂CH₂Si(OCH₃)₃

C₁₂H₂₅—O—(CH₂CH₂O)₉CH₂CONHCH₂CH₂C_{H2}Si(OCH₃)₃

CH₃—O—(CH₂CH₂O)₃COCH₂CH(COOH)CH₂CH₂CH₂Si(OCH₃)₃

CH₃—O—(CH₂CH₂O)₃COCH(CH₂COOH)CH₂CH₂CH₂Si(OCH₃)₃

C₁₂H₂₅—O—(CH₂CH₂O)₇COCH₂CH(COOH)CH₂CH₂CH₂Si(OCH₃)₃

C₁₂H₂₅—O—(CH₂CH₂O)₈COCH(CH₂COOH)CH₂CH₂CH₂Si(OCH₃)₃

C₁₇H₃₅—COO—(CH₂CH₂O)₉COCH₂CH(COOH)CH₂CH₂CH₂Si(OCH₃)₃

C₁₇H₃₃—COO—(CH₂CH₂O)₅COCH(CH₂COOH)CH₂CH₂CH₂Si(OCH₃)₃

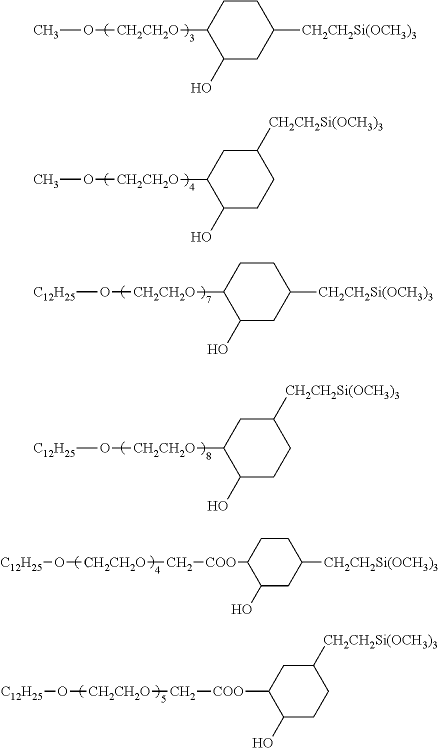

The compound of the surface-active silane coupling agent can be obtained through the following method.

In other words, the compound of the surface-active silane coupling agent is obtained by mixing the compound of the above Formula (1) and a silane coupling agent, and reacting them with each other at room temperature or during heating.

The mole ratio of the mixture of the compound of the above Formula (1) and a silane coupling agent used in the present invention may be equal, or either of them may be excessive. It is preferred that the mole ratio of them be equal or the ratio of the silane coupling agent is some excessive.

The reaction temperature is from room temperature to 200° C., preferably from room temperature to 100° C.

If necessary, a catalyst can be used.

When the terminal of the compound of the Formula (1) is hydroxyl group and the silane coupling agent has epoxy group, acid catalyst (for example, p-toluene sulfonic acid or sulfuric acid, etc.) can be used.

And, when the terminal of the surfactant is hydroxyl group and the silane coupling agent has isocyanate group, tin-based catalyst (for example, dibutyl tin diacetate and dibutyl tin dilaurate, etc.) or zirconia-based catalyst (for example, zirconium tetraacetylacetonate, etc.) can be used.

A solvent may, or may not be used. The solvent may be ether-based solvent (tetrahydrofuran, dioxane, 1,2-dimethoxyethane, etc.), aromatic hydrocarbons (toluene, xylene, etc.), ketone-based solvent (acetone, methylethylketone, methylisobutylketone, etc.), aprotic solvent (N,N-dimethylformamide, N,N-dimethylacetamide, N-methylpyrrolidone, etc.), etc.

Solvent-free is preferable.

The reaction time is usually 2 to 72 hours, preferably 8 to 48 hours.

The hydrolysate of surface-active silane coupling agent of the present invention is obtained through the following method. In other words, the hydrolysate of surface-active silane coupling agent can be obtained by dissolving the surface-active silane coupling agent into water-soluble solvents [for example, alcohol-based solvent (methylalcohol, ethylalcohol, isopropylalcohol, etc.), ether-based solvent (tetrahydrofuran, dioxane, etc.), ketone-based solvent (acetone, methylethylketone, etc.) or etc.], and hydrolyzing them by adding water.

The temperature during hydrolysis is not limited, and the boiling point at room temperature is preferable.

The concentration of the surface-active silane coupling agent to the solvent is 0.001 to 20 weight %, preferably 0.01 to 10 weight %.

It is not problematic if the amount of water used is more than equimolar to hydrolyzable group of the surface-active silane coupling agent.

Then, the modified metal oxide sol of the present invention is obtained by modifying a metal oxide sol with the above hydrolysate of surface-active silane coupling agent.

The modified metal oxide sol which is modified by the hydrolysate of surface-active silane coupling agent is obtained by adding metal oxide sol during or after hydrolysis of the silane coupling agent.

Also, the concentration of the metal oxide sol of raw material to the solvent to be added for preparing the modified metal oxide sol is 1-50 weight %, preferably 1-30 weight %.

The amount of the silane coupling agent to the metal oxide sol is equal or more than 0.01 mmol, preferably 0.05-10.0 mmol based on sol 1 g.

If the amount of the silane coupling agent to the metal oxide sol is less than 0.01 mmol, the antifog effect declines due to too low concentration of the silane coupling agent. If the amount of the silane coupling agent to the metal oxide sol is more than 10.0 mmol, self-condensation of the silane coupling agent occurs due to lack of silanol in the metal oxide and the layer-formation property declines.

The metal oxide sol may be silica sol, alumina sol or zirconia sol, preferably silica sol, more preferably organosilica sol.

Also, the organo sol is the colloidal solution which colloidal silica with surface modification of nano level is dispersed into the organic solvent such as alcohol, ketone, ether, toluene, etc.

For example, the organic solvent may be organosilica sol (methanolsilica sol, IPA-ST, IPA-ST, IPA-ST-UP, IPA-ST-ZL, EG-ST, NPC-ST-30, DMAC-ST, MEK-ST, MIBK-ST, PMA-ST and PGM-ST) from Nissan Chemical Industries, Ltd., or high-purity organosilica sol (PL-1-IPA, PL-2L-PGME and PL-2L-MEK) from FUSO CHEMICAL CO., LTD.

These may be used individually or in combination.

The modified metal oxide sol of the present invention comprises the metal oxide sol modified by the hydrolysate of surface-active silane coupling agent containing the hydrolyzed product of a silane coupling agent.

The modified metal oxide sol of the above [2] further comprises at least one of silicon-based compounds represented by the following Formula (2):

X—(R³)ₘ—Si(CH₃)ₙ(—Y)₃₋ₙ (2)

wherein X is selected from the group consisting of C₁ to C₂₀ linear or branched alkyl group, vinyl group, thiol group, amino group, chlorine atom, acryl group, methacryl group, alkyl ester group, styryl group, phenyl group, glycydoxy group, 3,4-epoxycyclohexyl group and blocked isocyanate group, R³ is C₁ to C₅ alkylene, m is 0 or 1, Y is the same or different C₁ to C₄ alkoxy group or hydroxyl group, and n is 0 or 1.

The hydrolyzed product of a silane coupling agent group comprising the silicon-based compounds of the Formula (2) can be obtained by the following method.

The condensation reaction generally occurs between the silicon-based compounds and the hydroxyl group (for example, silanol) of the metal oxide sol.

In other words, the hydrolyzed product of a silane coupling agent group comprising the silicon-based compounds of the Formula (2) can be obtained by adding the silicon-based compounds of the Formula (2) to the solution of the hydrolyzed product of a silane coupling agent group, and condensation-reacting them with the hydroxyl group (for example, silanol) of the metal oxide sol.

The silicon-based compounds of the Formula (2) are as follows:

CH₃Si(OCH₃)₃

CH₃Si(OC₂H₅)₃

C₈H₁₇Si(OCH₃)₃

C₈H₁₇Si(OC₂H₅)₃

C₁₈H₃₇Si(OCH₃)₃

C₁₈H₃₇Si(O₂H₅)₃

CH₂═CHSi(OCH₃)₃

CH₂═CHSi(OC₂H₅)₃

H₂NCH₂CH₂CH₂Si(OCH₃)₃

H₂NCH₂CH₂CH₂Si(OC₂H₅)₃

ClCH₂CH₂CH₂Si(OCH₃)₃

SHCH₂CH₂CH₂Si(OCH₃)₃

SHCH₂CH₂CH₂Si(CH₃)(OCH₃)₂

CH₂═CHCOOCH₂CH₂CH₂Si(OCH₃)₃

CH₂═C(CH₃)COOCH₂CH₂CH₂Si(OCH₃)₃

C₆H₅Si(OCH₃)₃

C₆H₅Si(OC₂H₅)₃

(CH₃)₃COCOCH₂CH₂SCH₂CH₂CH₂Si(OCH₃)₃

(CH₃)₃COCOCH₂CH₂SCH₂CH₂CH₂(CH₃)Si(OCH₃)₂

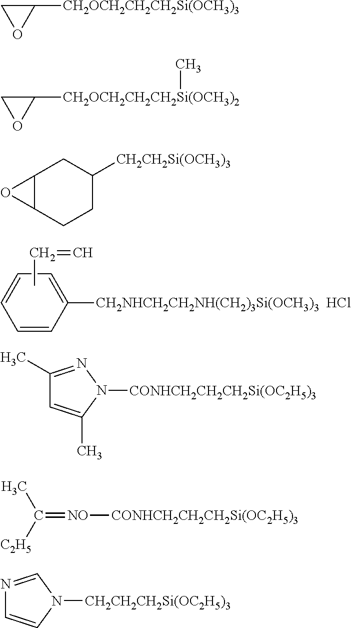

The amount of added silicon-based compounds of the Formula (2) is generally 0.01-5.0 mmol, preferably 0.01-3.0 mmol based on 1 g of the hydrolyzed product of a silane coupling agent group.

In the above range, the properties of the silicon-based compounds (for example, dispersibility, adhesion to the substrate, curing property, etc.) can be enhanced, self-condensation of the silicon-based compounds of the Formula (2) does not occur, and the layer-formation property is improved.

The temperature at the time of adding the silicon-based compounds of the Formula (2) is not limited, and the boiling point at room temperature is preferable.

The reaction temperature is not limited, and the boiling point at room temperature is preferable.

The reaction time is not limited, but is preferably 2 to 48 hours, more preferably 8 to 24 hours.

The silicon-based compounds of the Formula (2) can be used in the form of the mixture with the silane coupling agent of the present invention.

The hydrolyzed product of a silane coupling agent and the modified metal oxide sol of the present invention may further comprise metal alkoxide, metallic chelate and/or oligomer thereof.

The metal alkoxide or metallic chelate can be represented by the following Formula (3) and (4).

M(OR⁴)₄ (3)

M(OR⁴)₂R⁵₂ (4)

wherein M is silicon, titanium or zirconium, R⁴ is alkyl group, preferably C₁ to C₈ lower alkyl group, more preferably C₁ to C₄ lower alkyl group.

R⁴ may be methyl group, ethyl group, propyl group, isopropyl group, butyl group, pentyl group, hexyl group, etc.

R⁵ may be β-diketone group, specifically β-acetylacetonate group, etc.

The condensation reaction generally occurs between the metal alkoxide, metallic chelate and/or oligomer thereof and the hydroxyl group (for example, silanol) of the metal oxide sol.

In other words, the hydrolyzed product of a silane coupling agent and the modified metal oxide sol further comprising metal alkoxide, metallic chelate and/or oligomer thereof can be obtained by adding metal alkoxide, metallic chelate and/or oligomer thereof into the hydrolyzed product of a silane coupling agent group, and condensation-reacting them with the hydroxyl group (for example, silanol) of the metal oxide sol.

The metal alkoxide oligomer may be methylsilicate, ethylsilicate, etc. from COLCOAT CO., Ltd., ATORON (NSi-500), etc. from NIPPON SODA CO., LTD., ORGATIX TC-130, ORGATIX PC-200, ORGATIX PC-250, ORGATIX PC-601, ORGATIX PC-620, etc. from Matsumoto Fine Chemical Co., Ltd.

The amount of added metal alkoxide, metallic chelate and/or oligomer thereof is generally 0.1 to 500 weight %, preferably 0.5 to 200 weight %, more preferably 1.0 to 100 weight % based on the hydrolyzed product of a silane coupling agent group.

In the above range, the properties of the metal alkoxide, metallic chelate and/or oligomer thereof (for example, dispersibility, curing property, etc.) can be enhanced, and the layer-formation property and durability are improved.

The temperature at the time of adding metal alkoxide, metallic chelate and/or oligomer thereof is not limited, and the boiling point at room temperature is preferable.

The reaction temperature is not limited, and the boiling point at room temperature is preferable.

The reaction time is not limited, preferably 2 to 48 hours, more preferably 8 to 24 hours.

The metallic salts or bases may be added to the hydrolyzed product of a silane coupling agent and the modified metal oxide sol of the present invention to accelerate curing.

The metallic salts may be hydroxide (lithium hydroxide, sodium hydroxide, potassium hydroxide, cesium hydroxide, magnesium hydroxide, calcium hydroxide, etc.), acetate (lithium acetate, sodium acetate, potassium acetate, silver acetate, etc.), nitrate (calcium nitrate, barium nitrate, etc.) and metal oxide (silver oxide, etc.).

The bases may be ammonia, trimethylamine, triethylamine, tetramethyl ammonium hydroxide, tetraethyl ammonium hydroxide, etc.

The amount of added metallic salts or bases is generally 0.01 to 500 weight %, preferably 0.05 to 200 weight %, more preferably 0.1 to 100 weight % based on the hydrolyzed product of a silane coupling agent group.

The hydrolyzed product of a silane coupling agent and the modified metal oxide sol of the present invention may further comprise the compound having plural hydroxyl group, amino group, epoxy group, carboxyl group, thiol group, blocked isocyanate group, etc.

The compound may be polyethyleneglycol, polytetramethyleneglycol, polyester-based diol, polycarbonate-based diol, polycaprolactone-based diol, bisphenol A-epichlorohydrin resin, epoxy novolac resin, alicyclic epoxy resin, brominated epoxy resin, aliphatic epoxy resin, polyfunctional epoxy resin, polyethyleneimine, pentaerythritoltetrakis (3-mercaptobutyrate), 1,12-dodecanedioic acid, ε-caprolactam, methylethylketoxime, 3,5-dimethylpyrazole-blocked isophorone diisocyanate, 4,4′-dicyclohexylmethanediisocyanate, hexamethylenediisocyanate, toluenediisocyanate, etc.

By putting the hydrolyzed product of a silane coupling agent and the modified metal oxide sol of the present invention into the solvent, they may be used as an antifog additive.

The solvent—which does not react with the hydrolyzed product of a silane coupling agent and the modified metal oxide sol, and dissolve and/or disperse them—is not limited. For example, the solvent may be ether-based solvent (tetrahydrofuran, dioxane, etc.), alcohol-based solvent (methylalcohol, ethylalcohol, n-propylalcohol, isopropylalcohol, n-butylalcohol, etc.), ketone-based solvent (acetone, methylethylketone, methylisobutylketone, etc.) and aprotic solvent (N,N-dimethylformamide, N,N-dimethylacetamide, N-methylpyrrolidone, dimethyl sulfoxide, etc.) and water.

By putting the hydrolyzed product of a silane coupling agent and the modified metal oxide sol of the present invention into the coating solution, they may be used as an antifog coating composition.

The coating solution may be hard coating agent, anti-reflective coating agent, infrared absorption coating agent, gas barrier coating agent, anti-static coating agent, ultraviolet ray absorption coating, etc.

The antifog coating composition of the present invention may further comprise dilution solvent to enhance workability (handling and coatability). The dilution solvent—which does not react with the hydrolyzed product of a silane coupling agent and the modified metal oxide sol, and dissolve and/or disperse them—is not limited. For example, the dilution solvent may be ether-based solvent (tetrahydrofuran, dioxane, etc.), alcohol-based solvent (methylalcohol, ethylalcohol, n-propylalcohol, isopropylalcohol, n-butylalcohol, etc.), ketone-based solvent (acetone, methylethylketone, methylisobutylketone, etc.) and aprotic solvent (N,N-dimethylformamide, N,N-dimethylacetamide, N-methylpyrrolidone, dimethyl sulfoxide, etc.) and water.

In case the antifog coating composition comprises the dilution solvent, the amount of the dilution solvent is chosen so as to make the content of the hydrolyzed product of a silane coupling agent and the modified metal oxide sol 0.01 to 15 weight % (preferably 0.05 to 10 weight %, more preferably 0.05 to 7.5 weight %) based on total solvent.

The antifog coating composition of the present invention may further comprise surfactant to enhance workability (wettability to the substrate). The surfactant may be common hydrocarbon-based surfactant or fluoro-based surfactant (anionic surfactant, cationic surfactant, nonionic surfactant, amphoteric surfactant). The fluoro-based surfactant which shows effectiveness with a small amount is preferable.

The concrete examples of fluoro-based surfactant may be FTERGENT (brand name) from Neos Corporation as follows.

FTERGENT 100, FTERGENT 100C, FTERGENT 110, FTERGENT 150, FTERGENT 150CH, FTERGENT A-K, FTERGENT 501, FTERGENT 250, FTERGENT 251, FTERGENT 222F, FTERGENT 208G, FTERGENT 300, FTERGENT 310 and FTERGENT 400SW.

The antifog coating composition of the present invention can be applied on the substrate, sheet, film and fiber such as glass, plastic (polymethylmethacrylate, polyethyleneterephthalate, polybutyleneterephthalate, polyethylenenaphthalate, ABS, polycarbonate, polystyrene, epoxy, unsaturated polyester, melamine, diallylphthalate, polyimide, urethane, nylon, polyethylene, polypropylene, polyvinyl chloride, polybutadiene, polyisoprene, SBR, nitrile rubber, EPM, EPDM, epichlorohydrin rubber, neoprene rubber, polysulfide, butyl rubber, etc.), metal (iron, aluminium, stainless steel, titanium, copper, brass and alloy thereof, etc.), cellulose, cellulose derivatives, cellulose analogs (chitin, chitosan and porphyrin, etc.) or natural fiber (silk, cotton, etc.) for surface antifogging.

If necessary, the surface activation treatment (the treatment for elevating surface energy) such as primer treatment, plasma treatment, ultraviolet treatment or corona discharge treatment may be conducted to enhance adhesive property to the substrate.

The method of applying the coating solution comprising the antifog coating composition of the present invention may be dip coating, spin coating, flow coating, spray coating, etc.

After applying the coating solution by the above method and drying it, the mechanical property and chemical property of the coating layer can be enhanced by treating the material enhancing dehydrating condensation (for example, basic material: ammonia gas, etc.) for curing formed coating layer.

Or, the mechanical property and chemical property of the coating layer can be enhanced by conducting dehydrating condensation through heat treatment and curing.

Or, both of the two methods can be employed.

If the silicon-based compounds of Formula (2) are polymerizable by some means other than radical polymerization, cationic polymerization and dehydrating condensation such as ene-thiol reaction, polymerization by light or heat and dehydrating condensation can be conducted.

Also, polymerization and dehydrating condensation can be conducted at the same time. The light may be ultraviolet ray, visible ray, etc.

The compound which generates base or acid by light or heat can be used.

If the silicon-based compounds of Formula (2) are polymerizable, initiators which generate radicals by light or heat can be used.

Photoinitiators may be photoradical initiators such as 1-hydroxy-cyclohexyl-phenyl-ketone (IRGACURE 184), 2-benzyl-2-dimethylamino-1-(4-morpholino phenyl)-butanone-1 (IRGACURE 369), eutectic mixture of 1-hydroxy-cyclohexyl-phenyl-ketone (IRGACURE 184) and benzophenone (IRGACURE 500) 2,2-dimethoxy-1,2-diphenylethane-1-one (IRGACURE 651), bis(n⁵-2,4-cyclopentadiene-1-yl)-bis (2,6-difluoro-3-(1H-pyrrol-1-yl)-phenyl)titanium (IRGACURE 784), bis(2,4,6-trimethylbenzoyl)-phenylphosphine oxide (IRGACURE 819), 2-methyl-1[4-(methylthio)phenyl]-2-[morpholinopropan]-1-one (IRGACURE 907), 2-hydroxy-2-methyl-1-phenyl-propan-1-one (DAROCUR 1173), 1-[4-(2-hydroxyethoxy)-phenyl]-2-hydroxy-2-methyl-1-propan-1-one (IRGACURE 2959), liquid mixture of 20% 1-hydroxy-cyclohexyl-phenyl-ketone (IRGACURE 184) and 80% 2-hydroxy-2-methyl-1-phenyl-propan-1-one (DAROCUR 1173) (IRGACURE 1000), mixture of bis(2,6-dimethoxybenzoyl)-2,4,4-trimethyl-pentylphosphine oxide and 2-hydroxy-2-methyl-1-phenyl-propan-1-one (DAROCUR 1173) (ratio 1:3) (IRGACURE 1700), mixture of bis(2,6-dimethoxybenzoyl)-2,4,4-trimethyl-pentylphosphine oxide and 1-hydroxy-cyclohexyl-phenyl-ketone (IRGACURE 184) (ratio 1:3) (IRGACURE 1800) and mixture of bis(2,6-dimethoxybenzoyl)-2,4,4-trimethyl-pentylphosphine oxide, 1-hydroxy-cyclohexyl-phenyl-ketone (IRGACURE 184) (IRGACURE 1850), etc., cationic photoinitiators such as bis(4-tert-butylphenyl)iodonium hexafluorophosphate, bis(4-tert-butylphenyl)iodonium trifluoromethane sulfonate, diphenyliodonium hexafluoroalginate, diphenyliodonium hexafluorophosphate, diphenyliodonium trifluoromethanesulfonate, 4-isopropyl-4′-methyl diphenyliodonium tetrakis(pentafluorophenyl)borate, triphenyl sulfonium tetrafluoroborate, tri-p-tolylsulfonium hexafluorophosphate and tri-p-tolylsulfonium trifluoromethanesulfonate.

Thermal initiator may be azo-based initiator such as α,α′-azobisisobutyronitrile, 2,2′-azobis(4-methoxy-2,4-dimethylvaleronitrile), 2,2′-azobis(2,4-dimethylvaleronitrile), dimethyl 2,2′-azobis(2-methylpropionate), 2,2′-azobis(methylbutyronitrile, 1,1′-azobis(cyclohexane-1-carbonitrile), 2,2-azobis[N-(2-prophenyl)-2-methyl propionamide], 1-[(1-cyano-1-methylethyl)azo]formamide, 2,2′-azobis(N-butyl-2-methylpropionamide) and 2,2′-azobis(N-cyclohexyl-2-methylpropionamide, etc., peroxide-based initiator such as tert-butylperoxy-2-ethylhexanoate, tert-hexylperoxy-2-ethylhexanoate, 1,1,3,3-tetramethylbutylperoxy-2-ethylhexanoate, 2,5-dimethyl-2,5-di(2-ethylhexanoylperoxy) hexane, tert-butylperoxypivalate, tert-hexyl peroxypivalate, tert-butylperoxyneodecanoate, benzoylperoxide, dilauroylperoxide, di(3,5,5-trimethylhexanoyl)peroxide, tert-butylhydroperoxide, 1,1,3,3-tetramethylbutylhydroperoxide, tert-butylcumylperoxide, di-tert-hexylperoxide, diisopropylperoxydicarbonate, di-2-ethylhexylperoxydicarbonate, etc.

The catalyst thereof can be coated after adding it to the coating solution, or by spraying the solution dissolving the catalyst after layer formation or by exposure to catalytic atmosphere.

In the case of curing by only heat treatment, the temperature of the heat treatment is generally 60-250° C., preferably 80-225° C., more preferably 80-200° C.

The heat treatment time is generally 0.05-48 hours, preferably 0.1-48 hours, more preferably 0.5-36 hours.

In the case of using dehydrating condensation catalyst, the temperature of the heat treatment is from room temperature to the above temperature, and the heat treatment time is the same as given above.

In the case of using photoinitiator, the intensity of the irradiated light is generally 100-3000 mJ, preferably 500-2000 mJ, more preferably 750-2000 mJ.

In the case of using thermal initiator, the temperature of the heat treatment is generally 60-250° C., preferably 80-225° C., more preferably 80-200° C.

### DISCLOSURE OF THE INVENTION

The present invention will be described in more detail through the Examples. However, these Examples are only intended to describe the present invention exemplarily, and the protected circumstances of the present invention are not at all limited by them.

### Example 1

(1) By reacting 7.57 g of surfactant (BEAULIGHT LCA-H, polyoxyethylene lauryl ether acetate, acid value: 107) from Sanyo Chemical Industries, Ltd. with 3.4 g of 3-glycidoxypropyltrimethoxysilane for 2 days at 100° C. under Ar atmosphere, 10.3 g of surface-active silane coupling agent in which BEAULIGHT LCA-H and 3-glycidoxypropyl trimethoxysilane were bonded to each other through ester linkage was obtained. Through 1H-NMR detection, it was confirmed that the absorption of proton (2.62, 2.80, 3.16 ppm) at epoxy ring of 3-glycidoxypropyltrimethoxysilane—raw material—disappeared.

(2) By dissolving 1.0 g of surface-active silane coupling agent from (1) into 48.0 g of ethanol, adding 1.0 g of water into the mixture and heating under reflux overnight, 50.0 g of ethanol solution comprising hydrolyzed product of silane coupling agent was obtained.

(3) By dissolving 4.0 g of ethanol solution from (2) into 46.0 g of ethanol, 50.0 g of ethanol solution comprising the antifog additive of the present invention was obtained.

### Example 2

(1) By reacting 10.0 g of surfactant (EMULMIN L-90-S, ethylene oxide adduct of dodecyl alcohol, hydroxyl value: 98.3) from Sanyo Chemical Industries, Ltd. with 4.33 g of 3-isocyanatopropyltriethoxysilane (17.5 mmol) for 2 days at 100° C. under Ar atmosphere, 13.8 g of the compound in which isocyanatopropyltriethoxysilane and EMULMIN L-90-S were bonded to each other through urethane linkage was obtained. Through 1H-NMR detection, it was confirmed that the absorption of proton (3.27-3.32 ppm) of carbon which is bonded to isocyanate group of 3-(triethoxysilyl)propylisocyanate—raw material—disappeared and the absorption of proton (3.15-3.17 ppm) of carbon which is bonded to carbamate group of the object newly appeared.

(2) By dissolving 1.0 g of surface-active silane coupling agent from (1) into 48.0 g of ethanol, adding 1.0 g of water to the mixture and heating under reflux overnight, 50.0 g of ethanol solution comprising hydrolyzed product of silane coupling agent was obtained.

(3) By dissolving 4.0 g of ethanol solution from (2) into 46.0 g of ethanol, 50.0 g of ethanol solution comprising the antifog additive of the present invention was obtained.

### Example 3

(1) By reacting 20.2 g of surfactant (EMULMIN L-90-S, ethylene oxide adduct of dodecyl alcohol, hydroxyl value: 98.3) from Sanyo Chemical Industries, Ltd. with 8.4 g of 3-glycidoxypropyltrimethoxysilane using 0.1 g of p-toluene sulfonic acid as catalyst for 2 days at 100° C. under Ar atmosphere, 28.1 g of surface-active silane coupling agent in which EMULMIN L-90-S and glycidoxypropyl trimethoxysilane were bonded to each other through ether linkage was obtained. Through ¹H-NMR detection, it was confirmed that the absorption of proton (2.62, 2.80, 3.16 ppm) at epoxy ring of 3-glycidoxypropyltrimethoxysilane—raw material—disappeared.

(2) By dissolving 1.0 g of surface-active silane coupling agent from (1) into 48.0 g of ethanol, adding 1.0 g of water to the mixture and heating under reflux overnight, 50.0 g of ethanol solution comprising hydrolyzed product of silane coupling agent was obtained.

(3) By dissolving 4.0 g of ethanol solution from (2) into 46.0 g of ethanol, 50.0 g of ethanol solution comprising the antifog additive of the present invention was obtained.

### Example 4

(1) By reacting 16.4 g of Triethyleneglycolmonomethylether (Tokyo Chemical Industry Co., Ltd.) (100.0 mmol) with 24.7 g of 3-isocyanatepropyltriethoxysilane (100.0 mmol) for 2 days at 100° C. under Ar atmosphere, 40.5 g of surface-active silane coupling agent in which 3-isocyanatepropyltriethoxysilane and triethyleneglycolmonomethylether were bonded to each other through urethane linkage was obtained. Through 1H-NMR detection, it was confirmed that the absorption of proton (3.27-3.32 ppm) of carbon which is bonded to isocyanate group of 3-(triethoxysilyl)propylisocyanate—raw material—disappeared and the absorption of proton (3.13˜3.18 ppm) of carbon which is bonded to carbamate group of the object newly appeared.

(2) By dissolving 1.0 g of surface-active silane coupling agent from (1) into 48.0 g of ethanol, adding 1.0 g of water to the mixture and heating under reflux overnight, 50.0 g of ethanol solution comprising hydrolyzed product of silane coupling agent was obtained.

(3) By dissolving 2.0 g of ethanol solution from (2) into 48.0 g of ethanol, 50.0 g of ethanol solution comprising the antifog additive of the present invention was obtained.

### Example 5

(1) By dissolving 4.0 g of surface-active silane coupling agent from (1) of Example 3 to 33.5 g of ethanol, adding 6.0 g of organosilica sol (30% isopropanol solution, IPA-ST from NISSAN CHEMICAL INDUSTRIES, LTD.) and 6.5 g of water and heating under reflux during 24 hours, 50.0 g of ethanol solution comprising the modified silica sol by ethylene oxide adduct of dodecyl alcohol (about 2.78 mmol of ethylene oxide adduct of dodecyl alcohol is bonded based on 1 g of silica sol) using 3-glycidoxypropyl trimethoxysilane was obtained.

(2) By dissolving 2.5 g of ethanol solution from (1) into 47.5 g of ethanol and heating under reflux overnight, 50.0 g of ethanol solution comprising the antifog additive of the present invention was obtained.

### Example 6

(1) By stirring 4.81 g of 3,5-dimethylpyrazol (50.0 mmol) and 12.35 g of 3-isocyanatepropyltriethoxysilane (50.0 mmol) at room temperature during 3 days, 16.8 g of blocked isocyanate compound in which isocyanate group of 3-isocyanatepropyltriethoxysilane is blocked by 3,5-dimethylpyrazol was obtained. Through 1H-NMR detection, it was confirmed that the absorption of proton (3.27-3.32 ppm) of carbon which is bonded to isocyanate group of 3-(triethoxysilyl)propylisocyanate—raw material—was disappeared and newly the absorption of proton (3.32-3.39 ppm) of carbon which is bonded to urea group of the object appeared.

(2) By dissolving 10.0 g of ethanol solution comprising the modified silica sol by ethylene oxide adduct of dodecyl alcohol using 3-glycidoxypropyl trimethoxysilane from (1) of Example 5 into 39.8 g of ethanol and adding 0.2 g of blocked isocyanate compound in which isocyanate group of 3-isocyanatepropyltriethoxysilane is blocked by 3,5-dimethylpyrazol from (1), 50.0 g of ethanol solution comprising the modified silica sol—the antifog additive of the present invention—by ethylene oxide adduct of dodecyl alcohol and blocked isocyanate group (about 2.78 mmol of ethylene oxide adduct of dodecyl alcohol and about 1.6 mmol of blocked isocyanate group are bonded based on 1 g of silica sol) was obtained.

### Evaluation of Antifog Effect

The surfaces of the below substrates were modified by the antifog additives from Examples 1 to 6, the substrates were placed on the top of a hot tub of 70° C. and the antifog effect (checking occurrence of fogging when exposed to steam) was evaluated.

The result is shown in Table 1.

### Examples 1-5: Slide Glass, Example 6: Polycarbonate

(1) A slide glass {76 mm, 26 mm, 1.2 mm; which was immersed into a saturated solution of 2-propanol of sodium hydroxide during 24 hours, and washed and dried (60° C., 2 hours)} was immersed into treating solution (the antifog additive for surface). After taking out the slide glass, liquid was removed and heat treatment was conducted at 120° C. for 1 hour to obtain a surface-antifogging treated slide glass.

(2) A polycarbonate plate {76 mm, 26 mm, 1.0 mm; washed by ethanol} was immersed into treating solution (the antifog additive for surface). After taking out the polycarbonate plate, liquid was removed and heat treatment was conducted at 130° C. for 1 hour to obtain a surface-antifogging treated polycarbonate plate.

(3) Contact angles of surface-antifogging treated slide glass or polycarbonate plate were measured at 5 randomly chosen spots of the surfaces thereof using a contact angle measurement unit (Kyowa Interface Science Co., Ltd., DROP MASTER 500, liquid water content 2 μl, sensing gap 1000 ms, number of measurement 30 times), and the average value was calculated.

TABLE 1

| | Antifog effect |
|---|---|
| Example 1 | ◯ |
| Example 2 | ◯ |
| Example 3 | ◯ |
| Example 4 | ◯ |
| Example 5 | ◯ |
| Example 6 | ◯ |

◯: The antifog effect works (no fogging)

The present inventors tested various modified metal oxide sols having a sulfonic acid group disclosed in the Examples of the Patent document 1 and could not discern the antifog effect.

As shown in the result, it is obvious that the hydrolyzed product of a silane coupling agent group of the present invention shows the antifog effect.

### INDUSTRIAL APPLICABILITY

Since the antifog additive comprising the hydrolysate of surface-active silane coupling agent group has a good antifog effect for glass or plastic, etc., it is suitable as the antifog additive for glass, lens of eyeglasses, optical lens, mirror, etc. Moreover, since the antifog additive is coatable and prepared at low cost, it is suitable for a hydrophilizing agent, an antistatic agent, a hydrophilic coating composition, an antimicrobial agent, an ion (proton) conductor as well as an antifog additive.

1. A hydrolysate of surface-active silane coupling agent which is a reaction product of a surfactant represented by the following Formula (1) and a silane coupling agent having a functional group which can react with active hydrogen of the Formula (1):
R¹—X—(CH₂CH₂O)ₙ—Y (1)
wherein R¹ is C₁ to C₂₀ alkyl group (the alkyl group may comprise a benzene ring and double bond);
X is —O—, —COO— or —CONH—;
n is a natural number of 1 to 30; and
Y is hydrogen or —CH₂COOH.

2. A modified metal oxide sol which is obtained by modifying a metal oxide sol with a hydrolysate of surface-active silane coupling agent of claim 1.

3. The modified metal oxide sol according to claim 2, further comprising at least one of the silicon-based compounds represented by the following Formula (2):
X—(R³)ₘ—Si(CH₃)ₙ(—Y)₃₋ₙ (2)
wherein X is selected from the group consisting of C₁ to C₂₀ linear or branched alkyl group, vinyl group, thiol group, amino group, chlorine atom, acryl group, methacryl group, styryl group, phenyl group, glycydoxy group, 3,4-epoxycyclohexyl group and blocked isocyanate group;
R³ is C₁ to C₅ alkylene;
m is 0 or 1;
Y is the same or different C₁ to C₄ alkoxy group or hydroxyl group; and
n is 0 or 1.

4. The modified metal oxide sol according to claim 3, wherein the metal oxide sol as a raw material of the modified metal oxide sol is organo-silica sol.

5. An antifog additive comprising:
a hydrolysate of surface-active silane coupling agent according to claim 1
and/or
one or more modified metal oxide sols according to claim 2.

6. An antifog coating composition comprising:
a hydrolysate of surface-active silane coupling agent according to claim 1
and/or
one or more modified metal oxide sols according to claim 2.

7. A structure which is obtained by coating and curing the antifog coating composition according to claim 6.

8. An antifog additive comprising:
a hydrolysate of surface-active silane coupling agent according to claim 1
and/or
one or more modified metal oxide sols according to claim 3.

9. An antifog additive comprising:
a hydrolysate of surface-active silane coupling agent according to claim 1
and/or
one or more modified metal oxide sols according to claim 4.

10. An antifog coating composition comprising:
a hydrolysate of surface-active silane coupling agent according to claim 1
and/or
one or more modified metal oxide sols according to claim 3.

11. An antifog coating composition comprising:
a hydrolysate of surface-active silane coupling agent according to claim 1
and/or
one or more modified metal oxide sols according to claim 4.
